(19) United States
(12) Patent Application Publication
(10) Pub. No.: US 2020/0205354 A1
(43) Pub. Date: Jul. 2, 2020

(54) METHOD AND SYSTEM FOR SHORTENING GROWTH CYCLES IN PLANTS BY TIMING ADJUSTMENTS

(71) Applicants: Ido HEFER, Even Yehuda (IL); Or BLINDER, Petah Tikva (IL)

(72) Inventors: Ido HEFER, Even Yehuda (IL); Or BLINDER, Petah Tikva (IL)

(21) Appl. No.: 16/623,413

(22) PCT Filed: Jun. 18, 2018
(86) PCT No.: PCT/IL2018/050673

§ 371 Date: Dec. 17, 2019

Related U.S. Application Data
(60) Provisional application No. 62/521,454, filed on Jun. 18, 2017.

(51) Int. Cl. A01G 9/24; A01G 7/06; A01G 9/26; A01G 7/04

(52) U.S. Cl. CPC A01G 9/249; A01G 7/045; A01G 9/26; A01G 7/06

(57) ABSTRACT

Methods and systems control light used in growing plants, to create artificial or short days, of less than the standard 24 hour day. This artificial day, created by controlling light systems, maximizes growing time, and therefore, shortens the overall time for plant growth.

### CROSS-REFERENCES TO RELATED APPLICATIONS

This application is related to and claims priority from commonly owned, U.S. Provisional Patent Application Ser. No. 62/521,454, entitled: METHOD AND SYSTEM FOR SHORTENING GROWTH CYCLES IN PLANTS BY TIMING ADJUSTMENTS, filed on Jun. 18, 2017, the disclosure of which is incorporated by reference in its entirety herein.

### TECHNICAL FIELD

The present invention is directed to methods and systems for plant growth, in particular, those for cannabis plants.

### BACKGROUND OF THE INVENTION

Presently, plants are grown in accordance with a standard 24 hour day, which includes a daylight period and a night or dark period. These daylight and night periods define a light cycle for the standard 24 hour day. As a result, the various plant growth cycles are based on the local 24 hour day, with its daylight and night periods. For example, for any single given 24 hour day, City A may have a light cycle of a fourteen hour daylight period and a ten hour night period, while City B may have a light cycle of a nine hour daylight period and a fifteen hour night period. During this standard 24 hour day, plants will usually achieve high growth rates peaking at 95%-100% capacity during the first 50-60% of the day.

### SUMMARY OF THE INVENTION

The present invention takes advantage of the fact that since plants usually achieve high growth rates peaking at (approximately) 95%-100% capacity during the first (approximately) 50-60% of the 24 hour day, enough to produce full yield potential of floral organs pistil (calyx) per sq. meter. The remaining (approximately) 40-50% (9.6 to 12 hours) of the day or portions thereof, can be eliminated. Thus, the “day” ends short of 24 hours, and is an “artificial day” in accordance with the present invention, based on the eliminated time, and a new day is then started, by controlling the time period for a day. This artificial day of the present invention captures the high growth rates of plants, i.e., cannabis, which occur during (approximately) the first 50-60% of the standard or conventional 24 hour day (the terms “standard” and “conventional” are used interchangeably herein, when referring to a 24 hour day). As used herein, an “artificial day” is a time period less than the standard 24 hour day, where a period of light (known also as day light) is followed by a period of darkness, and vice versa. Accordingly, the present invention reduces the length of the day light hours in an artificial day, to trigger an increased growth mode, such that growth moderates are at their peak for the majority of the artificial day. This achieves a very fast growth cycle with full yield potential. The present invention provides methods and systems for creating this artificial or short day, of less than the standard 24 hour day, which maximizes growing time, and therefore, shortens the overall time for plant growth.

The present invention is directed to methods and systems which shorten the time of the vegetative and the flowering phase in plants, such as cannabis and in all other photoperiodic plants (e.g., “C3, C4, and cam plant types”), by operating plant growth and plant flowering cycles on an artificial “day”. This artificial day is less than the 24 hour standard day.

Embodiments of the present invention are directed to manipulating the standard “24 hour-whole day period,” with dedicated hardware that acts as a grow room computer, adjusting all the “enforcement grow rules” according to the artificial day and not by well-known 24 hours of a normal or standard whole day. The present invention changes the well-known photoperiods of the vegetative phase to artificial days of approximately 18-20 hours instead of the conventional 24 hour day, with, for example, approximately 14-16 hours of light and 4 hours of darkness for the vegetative phase, and for the flowering (blooming) phase, artificial days, for example, ranging from approximately 6 hours of light and approximately 12 hours of darkness, to artificial days of approximately 12 hours of darkness, with the remainder of the artificial day (the artificial day of a total of 18-20 hours) being light. With respect to the light or daylight of the aforementioned artificial days, this light or daylight, is from either natural light (sunlight) or artificial light, or combinations thereof, the artificial light, for example, generated by Ultraviolet (UV) or other light designed to mimic natural sunlight or its spectrums.

Embodiments of the present invention are directed to a method for growing plants. The method comprises: subjecting at least one plant to an artificial day including: providing light to the at least one to plant for a first predetermined time to accommodate at least 80 percent of the growth of the at least one plant; and, providing darkness for the at least one plant for a second predetermined time, wherein the combined first and second predetermined times are less than 24 hours.

Optionally, the second predetermined time follows the first predetermined time.

Optionally, the first predetermined time follows the second predetermined time.

Optionally, the first predetermined time and second predetermined time are based on the phase of the at least one plant.

Optionally, the phase of the at least one plant includes one or more of a vegetative phase and a flowering phase.

Optionally, the artificial day is approximately 18 hours.

Optionally, the vegetative phase includes the providing of light for the first predetermined time to accommodate the at least 80 percent of the growth of the at least one plant.

Optionally, the vegetative phase is such that first predetermined time is approximately 14-16 hours and the second predetermined time is approximately 2-4 hours.

Optionally, the flowering phase is such that the second predetermined time is at least approximately 12 hours.

Optionally, the vegetative phase and the flowering phase for the at least one plant includes a plurality of the artificial days to define a growth cycle for the at least one plant.

Optionally, the providing light includes providing at least one of natural light, artificial light, or a combination of natural and artificial light.

Optionally, the providing light includes providing light at a predetermined intensity.

Optionally, the at least one plant includes cannabis.

Embodiments of the present invention are directed to a system for growing plants in grow facilities. The system comprises: a light system; and, a controller for controlling the light system. The controller causes the light system to operate on an artificial day of less than 24 hours. The controller is programmed to: cause the light system to provide light to the at least one to plant for a first predetermined time to simulate a daylight portion of the artificial day to accommodate at least 80 percent of the growth of the at least one plant; and, cause the light system to cease operations to provide darkness for the at least one plant for a second predetermined time to simulate the night portion of the artificial day.

Optionally, the system is such that the light system includes lights selected from the group consisting of ultraviolet lights, light emitting diodes, and combinations thereof.

Optionally, the system is such that it additionally comprises: at least one light intensity sensor in electronic communication with the controller, wherein the controller is programmed to adjust the light intensity of the light system in response to readings from the at least one light intensity sensor.

Optionally, the system is such that the at least one light intensity sensor includes a spectroradiometer.

Optionally, the system is such that the controller is additionally programmed to: control the operation of the light system such that the first predetermined time and second predetermined time are based on the phase of the at least one plant including one or more of a vegetative phase and a flowering phase.

Optionally, the system is such that the controller is additionally programmed such that the artificial day is approximately eighteen hours.

Optionally, the system is such that the controller is additionally programmed to: cause the light system to operate during the vegetative phase such that first predetermined time is approximately 14-16 hours and the second predetermined time is approximately 2-4 hours.

Optionally, the system is such that the controller is additionally programmed to: cause the light system to operate during the flowering phase such that the second predetermined time is at least approximately 12 hours.

Optionally, the system is such that the controller is additionally programmed to: control the operation of the light system for a plurality of artificial days including a growth cycle defined by artificial days of the vegetative phase and the flowering phase for the at least one plant.

Optionally, the system is such that it additionally comprises sensors for one or more of: temperature, humidity, carbon dioxide, nutrients, and irrigation, the sensors in electronic communication with the controller, wherein the controller is programmed to cause adjustment of the temperature, humidity, carbon dioxide, nutrients and irrigation to the at least one plant.

Optionally, the system is such that the grow facilities are selected from the group consisting of grow rooms, greenhouses and outdoor facilities.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram of a system in accordance with an embodiment of the present invention; and,

FIGS. 2A and 2B form a flow diagram of a process in accordance with an embodiment of the present invention.

### DETAILED DESCRIPTION OF THE DRAWINGS

The present invention is directed to methods and systems for growing plants based on an artificial day of less than twenty four hours. The plants include, for example, flowering plants, which produce buds and floral organs, such as in cannabis plants, such as pistils in their flowering phase. These buds and floral organs from the cannabis plant are used to produce dried flowers, aromatic oils, such as cannabis oil, as well as seeds and other cannabis byproducts.

The present invention is directed to an “artificial day” of less than the conventional day of 24 hours, to take advantage of a plant's, including cannabis plants, high growth rate, which peaks at approximately 95%-100% capacity during the first approximately 50-60% of the 24 hour day, enough to produce full yield potential of floral organs pistil (calyx) per sq. meter. The remaining approximately 40-50% (9.6 to 12 hours) of the conventional day, or portions thereof, can be eliminated. For example, the present invention provides for an artificial day having daylight periods to capture at least 80%, and typically 95%-100%, of the growth, followed by darkness periods, so that the artificial day is less than 24 hours. A typical artificial day is approximately 18-24 hours.

The present invention is directed to methods and systems which shorten the time of the vegetative and the flowering phase in plants, such as cannabis and in all other photoperiodic plants (e.g., “C3, C4, and cam plant types”), by operating plant growth or vegetative and plant flowering phases on an “artificial day”. This artificial day is less than the 24 hour standard day. The artificial day includes a light period, to mimic the daylight of the day (i.e., artificial day), and a dark or darkness period, to mimic the nighttime or night of the day (i.e., artificial day).

Embodiments of the present invention are directed to manipulating the standard “24 hour-whole day period,” with dedicated hardware that acts as a grow room computer, adjusting all the “enforcement grow rules” according to the artificial day and not by well-known 24 hours of a conventional or standard whole day. The present invention changes the well-known photoperiods of the vegetative phase to artificial days of approximately 18-20 hours instead of the conventional 24 hour day, with, for example, approximately 14-16 hours of light and approximately 2-4 hours of darkness for the vegetative phase, and for the blooming (flowering) phase, artificial days, for example, ranging from approximately 6 hours of light and approximately 12 hours of darkness, to another artificial day of approximately 12 hours of darkness, with the remainder of the artificial day (the artificial day of 18-20 hours total) being light. With respect to the light or daylight of the aforementioned artificial days, this light or daylight, is from either natural light (sunlight), artificial light, or combinations thereof, with the artificial light, for example, generated by Ultraviolet (UV) or other light designed to mimic natural sunlight or its spectrums.

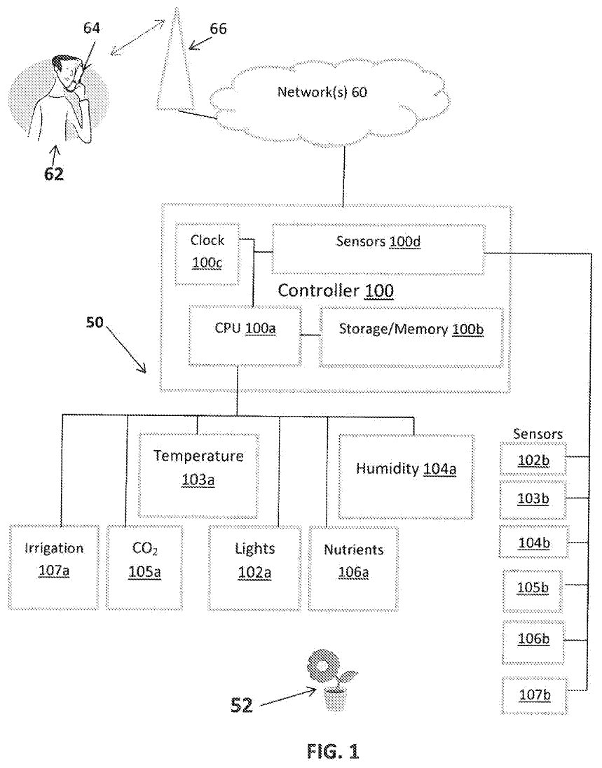

FIG. 1 shows a system 50 in accordance with an embodiment of the present invention. The system 50 is for growing a plant 52, which is, for example, cannabis, including various strains and variants thereof. The system 50 can be controlled locally, via a controller 100, or remotely, by a grower/user 62 via a mobile computer, such as a smart phone 64, or other computer, over a communications network(s) 60, which includes, networks such as the Internet, cellular networks (accessed by smart phones 64 via cellular towers 66). The system 50 can be used in grow facilities such as green houses, grow rooms, and outdoor facilities, which may be covered with the cover able to be opened, or other grow facility. All of the aforementioned grow facilities are such that the amount of light and the intensity of the light, and exposure to natural light, artificial light, or combinations thereof, as well as darkness can be controlled manually, automatically, or by combinations thereof.

The system 50 includes a controller 100, whose logic is controlled by a central processing unit CPU 100a of one or more computerized processors, including data processors. The CPU 100a is linked to storage/memory 100b, which stores machine-executable instructions for performing the processes disclosed herein, as executed by the CPU 100a. The storage/memory 100b is any conventional storage media. The storage/memory 100b stores machine executable instructions for execution by the CPU 100a, to perform the processes of the invention. The storage/memory 100b also includes machine executable instructions associated with the operation of the components 102a-107a and sensors 102b-107b, performed by the controller 100, as well as having storage for various threshold parameters for day/light and night/dark conditions. The CPU 100a also links to a clock 100c, which provides the timing for an “artificial day”, e.g., less than 24 hours, as well as being linked to a sensor coordinating unit 100d. “Linked” as used herein includes both wired or wireless links, either direct or indirect, and placing the computers, including, servers, components and the like, in electronic and/or data communications with each other.

The system 50 is formed of components, linked, either directly or indirectly to the CPU 100a, and controlled by the controller 100, including the CPU 100a as coordinated with the clock 100c. The CPU 100a also controls the processor based sensor coordinating unit 100d, which in turn, controls communications (e.g., signals and the like) for the various sensors 102b, 103b, 104b, 105b, 106b.

These components include, lights 102a and light sensors 102b, forming a light system, heaters/coolers, represented by temperature 103a and temperature sensors 103b, humidifiers/dehumidifiers, represented by humidity 104a and humidity sensors 104b, carbon dioxide (CO₂) sources 105a and CO₂ sensors 105b, nutrient distribution system(s) 106a and nutrient sensors 106b, and irrigation systems 107a and irrigation sensors 107b.

The lights 102a are, for example, ultraviolet (UV) lights, Light Emitting Diodes (LEDs), or other lights designed to mimic natural sunlight or its spectrums. The lights 102a are such that their intensity can be controlled, via the controller 100. For example, the LEDs may be controlled by a COB (Chip on Board) as part of the controller 100. The controller 100, via the clock 100c, controls the lights 102a turning ON and OFF. Also, in grow facilities where there are roofs, windows and the like for natural light entry, the controller 100 may be such that it opens/closes roofs, windows and the like, so as to go between light and dark.

The temperature controller 103a is, for example, a heating/cooling unit. The CO₂ sources 105a include, for example tanks of CO₂ or lines connected to an external CO₂ source. The nutrient distribution systems 106a, include, for example, sprayers, depositing and dosage pump systems (for placing nutrients in the irrigation water and/or nutrient solution). The irrigation system 107a includes a water and/or nutrient solution supply or source (controlled by the nutrient system 106a), as well as channels and/or conduits and/or pumps (not shown), arranged to distribute the water and/or nutrient solution around the plants 52.

Example sensors for sensing parameters, include those for light intensity 102b, temperature 103b, humidity 104b, CO₂ 105b, nutrients 106b and irrigation liquid levels and flows 107b. Light sensors 102b sense light intensity, wavelength and other light properties. For example, some of the light sensors 102b are spectroradiometers. Communications, sending and receiving signals to/from the sensors 102b, 103b, 104b, 105b, 106b and 107b, is with the sensor coordinating unit 100d, which is in, turn, controlled by the CPU 100a. When, for example, a sensed parameter reaches a threshold values for the parameter, as stored in the storage/memory 100b, cloud storage (not shown), or other storage, as programmed into the controller 100 by the grower/user 62, for example, via a mobile device 64 or other computer linked to the network(s) 60, the CPU 100a transmits signals to adjust the requisite parameter in the corresponding component(s) 102a-107a. The sensing operations performed by the sensors 102b, 103b, 104b, 105b, 106b and 107b are typically at regular intervals, such as every fifteen minutes, with the operation of each sensor at different times, or simultaneously, within the interval.

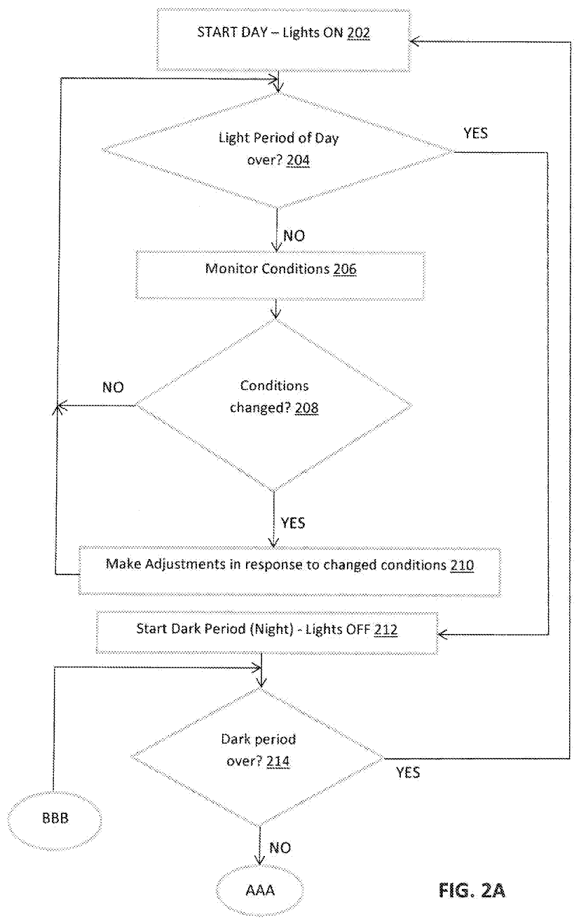

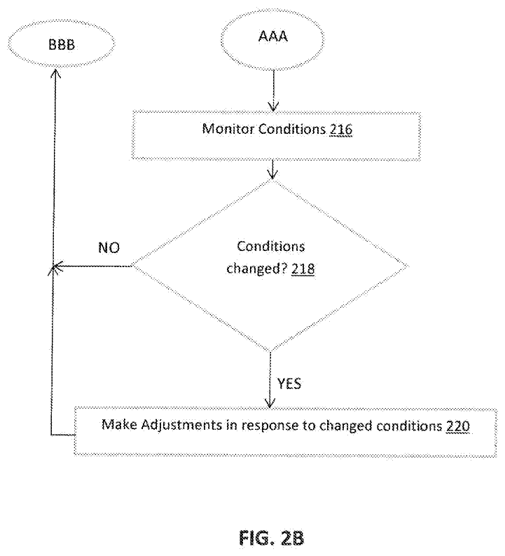

Attention is now directed to FIGS. 2A and 2B, which shows a flow diagram detailing computer-implemented processes, performed by the controller 100 of the system 50, in accordance with embodiments of the disclosed subject matter, for growing plants, for example cannabis. Reference is also made to elements shown in FIG. 1. The aforementioned processes and sub-processes can be, for example, performed manually, automatically, or a combination thereof, and, for example, in real time.

Initially, at block 202, the “day”, which is an artificial day in accordance with the invention, starts. As stated above, this “artificial day” is shorter than the conventional 24 hour day. At this START, the lights are ON (or automatically turned ON), and the clock 100c, sets or resets to the start of the time period for the short or artificial day, for example, as to represented by the light period of the day. The process moves to block 204, where based on the clock 100c, it is determined whether the light (day light) period of the artificial day is over. If yes, the process moves to block 212. If no, the process moves to block 206, where day conditions, e.g., parameters, are monitored by the sensors 110, typically at timed intervals, as controlled by the clock 100c, but could be random, also controlled by the clock 100c.

The process moves to block 208, where the CPU 100a determines whether conditions, e.g., parameters must be adjusted based on the sensed conditions, when compared to the thresholds for the sensors, for day/light conditions/parameters, as programmed into the controller 100 by the grower/user 62. If no, the process returns to block 204. If yes, the process moves to block 210, where the requisite parameter(s) is/are adjusted by the CPU 100a (responding to signals from the sensors 102b, 103b, 104b, 105b, 106b, 107b, as communicated by the sensor coordinating unit 100d), causing action of the lights 102a, heaters/coolers, represented by temperature 103a, humidifiers/dehumidifiers, represented by humidity 104a, carbon dioxide (CO₂) sources 105a, nutrient distribution system(s) 106a, and the irrigation system 107a, in order to adjust the requisite parameter. This first cycle of blocks 202-210 continues until the time period for the light (day light) period of the artificial day ends.

Once the light period for the artificial day ends, the process moves to block 212. At block 212, the dark period or night for the artificial day starts, with the lights OFF, for example, the lights 102a were turned OFF automatically, as signaled by the CPU 100a.

The process moves to block 214, where based on the clock 100c, it is determined whether the dark or night period of the artificial day is over. If yes, the process moves to block 202, from where it resumes, as detailed above. If no, the process moves to block 216, where night conditions, e.g., parameters, are monitored by the sensors 102b, 103b, 104b, 105b, 106b, 107d typically at timed intervals, as controlled by the clock 100c, but could be random, also controlled by the clock 100c.

The process moves to block 218, where the CPU 100a determines whether conditions, e.g., parameters must be adjusted based on the sensed conditions, when compared to the thresholds for the sensors, for night/dark conditions/parameters, as programmed into the controller 100 by the grower/user 62. If no, the process returns to block 214. If yes, the process moves to block 220, where the requisite parameter(s) is/are adjusted by the CPU 100a causing action of the lights 102a, e.g., light intensity, heaters/coolers, represented by temperature 103a, humidifiers/dehumidifiers, represented by humidity 104a, carbon dioxide (CO₂) sources 105a, nutrient distribution system(s) 106a and irrigation system 107a, in order to adjust the requisite parameter(s).

This second cycle of blocks 212-220 continues until the time period for the dark or night period of the artificial day ends, by the lights 102a, being turned ON, once the clock 100c determines the end of the dark or night period (of the artificial day). The turning ON and OFF of the lights 102 is controlled by the CPU 100a via the clock 100c, to create the artificial day of the present invention.

Example growth phases (growth cycles), based on the “artificial days” of the invention are now described.

### Example Phases for Cannabis “Northern Lights” Strain

Vegetative Phase—Lights ON 14 hours Lights OFF 4 hours, DAY (Artificial day) is 18 hours total. During the vegetative phase, the plant itself grows.

Flowering (Blooming) Phase—Lights ON 6 hours Lights OFF 12 hours, DAY (Artificial Day) is 18 hours total. During the flowering phase the plant produces buds, which ultimately develop into flowers from which seeds can be produced.

The process described above in FIGS. 2A and 2B may be used with the Vegetative Phase and the Flowering Phase.

The growth achieved during an 18 hour (approximately) artificial day, formed of a first predetermined time period for light, representative of day light, so as to simulate the day light portion of the artificial day, and a second predetermined time period of darkness, representative of night, to simulate the night of the artificial day as disclosed, can be the equivalent to that achieved during a standard 24 hour day. Accordingly, by running 18 hour artificial days, the same growth and yield can be achieved in 75% of the time, of a standard 24 hour day. Reduced day lengths of the artificial days also result in reduced power consumption, such as that for lights 102a, heat/cooling 103a, nutrient distribution 106a and irrigation 107a, and the like, allowing for increased growth which uses less power, than would be the case with grows based on standard or conventional 24 hour days.

For example, an average crop grown from seed using a conventional 24 hour day/night cycle will have a 4 week vegetative (growth) phase and an 8 week flowering phase. This equates to 28 days at 18 hours/day and 56 days at 12 hours/day, resulting in 1176 hours of light over 12 weeks.

An accelerated crop using an 18 hour artificial day of light/dark periods as disclosed herein, achieves the same yields using a 3 week vegetative phase and a 6 week flowering phase. This equates to 21 days at 14 hours/day and 42 days at 6 hours/day, equals 546 hours of light over 9 weeks resulting in a 40% reduction in power consumption and a 25% reduction in crop time.

To achieve the aforementioned growth rates, maximum light intensities and CO₂ enriched conditions (between 1500-2000 ppm), are provided by the system 50. For example, lighting is minimum for (High Pressure Sodium) HPS lamps 600 W per square meter or equivalent light source (85000 lumen per sq. meter). The humidity must remain high, for example, at 70-80 RH %, so the plants can absorb the high levels of CO₂ and use the nutrients at maximum efficiency.

While an 18 hour artificial day has been described for an example “Northern Lights” Cannabis Strain, other artificial days of lengths less than 24 hours are also permissible, provided they have a light period followed by a dark period, or vice versa, defining the total day length.

It will be apparent to those skilled in the art that various modifications and variations can be made to various embodiments described herein without departing from the spirit or scope of the teaching herein. Thus, it is intended that various embodiments cover other modifications and variations of various embodiments within the scope of the present teachings.

The implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, RF, cloud connection or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for growing plants comprising:
subjecting at least one plant to an artificial day including:
providing light to the at least one to plant for a first predetermined time to accommodate at least 80 percent of the growth of the at least one plant; and,
providing darkness for the at least one plant for a second predetermined time,
wherein the combined first and second predetermined times are less than 24 hours.

2. The method of claim 1, wherein on of:
the second predetermined time follows the first predetermined time; or,
the first predetermined time follows the second predetermined time.

3. (canceled)

4. The method of claim 2, wherein the first predetermined time and second predetermined time are based on the phase of the at least one plant; and, the phase of the at least one plant includes one or more of a vegetative phase and a flowering phase.

5. (canceled)

6. The method of claim 4, wherein the artificial day is approximately 18 hours.

7. The method of claim 6, wherein the vegetative phase includes: 1) the providing of light for the first predetermined time to accommodate the at least 80 percent of the growth of the at least one plant; and/or 2) phase is such that first predetermined time is approximately 14-16 hours and the second predetermined time is approximately 2-4 hours.

8. (canceled)

9. The method of claim 7, wherein the flowering phase is such that the second predetermined time is at least approximately 12 hours.

10. The method of claim 9, wherein the vegetative phase and the flowering phase for the at least one plant includes a plurality of the artificial days to define a growth cycle for the at least one plant.

11. The method of claim 1, wherein the providing light includes providing at least one of natural light, artificial light, or a combination of natural and artificial light.

12. (canceled)

13. The method of claim 1, wherein the at least one plant includes cannabis.

14. A system for growing plants in grow facilities comprising:
a light system; and,
a controller for controlling the light system to operate on an artificial day of less than 24 hours, the controller programmed to:
cause the light system to provide light to the at least one to plant for a first predetermined time to simulate a daylight portion of the artificial day to accommodate at least 80 percent of the growth of the at least one plant; and,
cause the light system to cease operations to provide darkness for the at least one plant for a second predetermined time to simulate the night portion of the artificial day.

15. The system of claim 14, wherein the light system includes lights selected from the group consisting of ultraviolet lights, light emitting diodes, and combinations thereof.

16. The system of claim 15, additionally comprising:
at least one light intensity sensor in electronic communication with the controller, wherein the controller is programmed to adjust the light intensity of the light system in response to readings from the at least one light intensity sensor; and,
sensors for one or more of: temperature, humidity, carbon dioxide, nutrients, and irrigation, the sensors in electronic communication with the controller, wherein the controller is programmed to cause adjustment of the temperature, humidity, carbon dioxide, nutrients and irrigation to the at least one plant.

17. (canceled)

18. The system of claim 14, wherein the controller is additionally programmed to: control the operation of the light system such that the first predetermined time and second predetermined time are based on the phase of the at least one plant including one or more of a vegetative phase and a flowering phase.

19. The system of claim 18, wherein, the controller is additionally programmed such that the artificial day is approximately eighteen hours.

20. The system of claim 16, wherein the controller is additionally programmed to perform one or more of:
cause the light system to operate during the vegetative phase such that first predetermined time is approximately 14-16 hours and the second predetermined time is approximately 2-4 hours;
cause the light system to operate during the flowering phase such that the second predetermined time is at least approximately 12 hours; or,
control the operation of the light system for a plurality of artificial days including a growth cycle defined by artificial days of the vegetative phase and the flowering phase for the at least one plant.

21. (canceled)

22. (canceled)

23. (canceled)

24. (canceled)
